(19) United States
(12) Patent Application Publication
(10) Pub. No.: US 2021/0049562 A1
(43) Pub. Date: Feb. 18, 2021

(54) METHOD AND APPARATUS FOR CREATING A CRYPTOCURRENCY OR DIGITAL LEDGER TOKEN INDEX FOR BLOCKCHAINS

(71) Applicants: Clarke J Long, San Francisco, CA (US); Ian L Sayers, South Shields (GB)

(72) Inventors: Clarke J Long, San Francisco, CA (US); Ian L Sayers, South Shields (GB)

(21) Appl. No.: 16/212,557

(22) Filed: Dec. 6, 2018

Related U.S. Application Data
(60) Provisional application No. 62/614,479, filed on Jan. 7, 2018.

(51) Int. Cl. G06Q 20/06; H04L 9/06

(52) U.S. Cl. CPC G06Q 20/065; H04L 2209/56; H04L 2209/38; H04L 9/0643

(57) ABSTRACT

A method for the trading of cryptocurrencies using a modified blockchain approach. It facilitates the creation of a blockchain based indexed record consisting of customized grouping of various Cryptocurrencies or Digital Ledger Tokens (collectively abbreviated as CCDLTs). In addition the consumers can purchase or sell multiple Cryptocurrencies or Digital ledger Tokens (CCDLTs) of an indexed fund, using a single purchase order instead of the current method of manually placing multiple individual purchase orders.

### BACKGROUND TO INVENTION

A Cryptocurrency or Digital Ledger Token (CCDLT) can be thought of as a digital currency created to work as a medium of exchange using cryptography to secure transactions (REFERENCE 1). Cryptocurrencies and Digital Ledger Tokens (REFERENCE 2) are both based on the concept of blockchain (REFERENCE 3) technology. A blockchain is a digitized, decentralized, public ledger of all cryptocurrency transactions. This public ledger is hosted on an internet-network that is maintained by multiple computers known as “nodes”. Nodes are owned by various individuals or organizations participating in digital currency transactions. Constantly evolving as ‘completed’ blocks, the transactions are recorded and appended to the chain in chronological order, this data structure allows participants to keep track of digital currency transactions without central recordkeeping, such as is the case with today's commercial banking transactions where each transaction is recorded by the commercial bank where the participant maintains an account. Each node of a blockchain, represented by a computer connected to its' respective digital currency network, automatically receives a copy of the blockchain activity. Originally developed as an accounting method for the virtual currency Bitcoin, blockchains—which use what's known as distributed ledger technology (DLT)—are appearing in a variety of commercial applications today. Currently, the technology is primarily used to verify transactions that employ digital currencies. It is possible to use this technology to digitize, code, and insert practically any digital document or signature into a blockchain. Doing so creates an indelible record that cannot be changed. Furthermore, the record's authenticity can be verified by the entire user community, using the blockchain instead of a single centralized authority. A block is the ‘currently active’ part of a blockchain which records some or all of the recent transactions. Once completed or finished, a block goes into the blockchain as a permanent record. Each time a block is written to the blockchain a new active block is generated. There are a countless number of such blocks in a blockchain, connected to each other (like links in a chain) in chronological order. Every block contains a hash (a numeric, or fixed-size character output from a variable-sized piece of text or other data) of the previous block. A blockchain has complete information about different user addresses and their balances obtained from the genesis block (the very first block) to the most recently completed block. Blockchain is designed so these transactions are immutable, meaning they cannot be deleted. Blocks are added through cryptography, ensuring that they remain meddle-proof: that is, the data can be distributed, but not copied. In addition, it should be noted that Cryptocurrencies or Digital Ledger Tokens (CCDLT's) can be purchased in fractions—for example if the price of a CCDLT “X” is $1 per unit, a consumer can purchase half of the unit for $0.50 and own half a unit of CCDLT “X”. While the cryptocurrency Bitcoin is the most well-known digital currency in the world, there are many others that exist. From 2015 thru 2017 there was exponential growth globally in the number of different digital currency created (REFERENCE 4). The number of new digital currencies being created is growing at such a rapid pace that industry experts (REFERENCE 5) predict that by 2025 the total global market capitalization of digital currency will reach $5 trillion. The pace of new digital currency emerging continues to grow rapidly as the industry expands.

Each new digital currency is created with some new or unique technological function—attempting to differentiate themselves from Bitcoin by offering improved features such as, for example, better cyber-security or decreased transaction costs (REFERENCE 6). In addition, digital currencies have been known to “soft fork” (REFERENCE 7), “hard fork” (REFERENCE 8) or “chain-split” (REFERENCE 9); all of which ultimately result in some form of mutation or alteration to the respective digital currency. These practices are quite frequent in the digital currency industry and often cause confusion for industry participants that wish to track and organize digital currencies they are interested in. In addition to the rapid growth of new and available digital currencies, forking and chain-splitting also necessitate the need for an efficient indexing method as they add additional complexity to the industry. While this patent addresses digital currency methods that are commonly performed today, such as “soft-forks” and “hard-forks”, it also addresses current “chain-splits” as well as any future form of chain splitting that may be envisioned by the digital currency industry.

As can be seen by anyone skilled in the arts of digital currency or finance, the invention described in this patent provides a method and apparatus that allows for the indexing and recording of various digital currency groupings into an indelible blockchain protocol, thereby explicating the process of tracking and organizing digital currencies.

Currently there are no methods for consumers to create their own customized and immutable unique digital currency index. Some companies offer digital currency indexed funds for purchase, but these Index Funds contain digital currency that are hand-selected by the company's managers and do not allow any customization by their customers (REFERENCE 10). Consequently, if a consumer wishes to create their own unique digital currency index and make it immutable by inserting it into a Blockchain Protocol, they are unable to do so because there are no such services or methods that offer this capability today. Furthermore, if a customer wishes to purchase a unique digital currency indexed fund, they are unable to do so because no such are services exist or are currently offered.

FIG. 2 and FIG. 3 show prior art from U.S. Pat. No. 9,848,089: “Methods and apparatus to generate an overall performance index”. The figures illustrate a method used to generate an index from a set of data values originating from multiple different standard wireless network parameters. Whereas the U.S. Pat. No. 9,848,089 teaches how to use various invariant wireless network parameters that measure specific aspects of wireless network performance to form an index, the unique method described in this patent utilizes data sources containing information about varying transactable assets such as Cryptocurrencies or Digital Ledger Tokens. In addition, U.S. Pat. No. 9,848,089 utilize accumulated wireless-network data values to generate metrics that are then mathematically combined to generate a rudimentary performance index that is not curated. In contrast, the method described herein utilizes the accumulated transactable asset data to generate a curated list Cryptocurrencies or other transactable assets. This curated list of transactable assets, such as Cryptocurrencies or Digital Ledger Tokens, is then used to generate a unique index, such as a UCCDLTI (Unique Cryptocurrency or Digital Ledger Token Indexes). Furthermore, the method described in this patent utilizes a blockchain protocol to record the generated Indexes, making them immutable, whereas U.S. Pat. No. 9,848,089 does not record their generated Indexes in a blockchain protocol. It can be further appreciated that in addition to making a generated index immutable, the process of recording them in a blockchain protocol also distributes these recorded indexes across multiple nodes. This ensures that in the event one node is physically destroyed, that there will still be a record of the unique index and its' contents that can be accessed via another node. This feature is not taught in the U.S. Pat. No. 9,848,089.

The illustrations in FIG. 4 and FIG. 5 represent typical methods utilized by present-day digital currency brokers and should not be taken as all encompassing. Variations do exist within the digital currency brokerage and exchange industries. However, they are representative of the typical methods of operations in the current digital currency brokerage industry (REFERENCE 11).

FIG. 4 illustrates the typical end-to-end process for a Customer 400 purchase of a single digital currency or CCDLT 412. When a Customer 400 places an order to purchase a CCDLT 412, he may only identify one CCDLT 412 per order. Customer 400 sends his order to the Order Desk 403 and the CCDLT Broken 402. Order Desk 403 then routes the Purchase Order 404 to Exchange1 405. If the order cannot be filled by Exchange1 405, then the Order Desk 403 will attempt to route it to additional Exchanges 2-x 406. Once the Purchase Order 404 is routed to the various Exchanges, they notify Broken 402 that there are or are not contra-orders available to fill the Customer's 200 Purchase Order 204. A contra-order is a standard term in the securities industry which is used to define an “opposing transaction order” for example, if there is a “buy” order issued, then a “contra-order” would be the exact opposite “sell” order. Once the Broken 402 is notified about the Contra-Orders 407/408 that are available, the Order Desk 403 Selects 410 “Select Buy” to fill Customer's 400 Purchase Order 404. The resulting purchased CCDLT 412 is then transferred to the Customer's CCDLT Wallet 414 which is housed at the Broken 402.

FIG. 5 illustrates the typical end-to-end process use by a Customer 500 to purchase multiple CCDLT's 513/533. It is essentially the same as the previous process repeated multiple times for as many CCDLT's as they wish to purchase. If a Customer 500 wishes to purchase multiple CCDLT's, he must manually repeat the above process. It should be noted that the end-to-end process for purchasing a single CCDLT 515 is the same for purchasing a different CCDLT in process 535. Even if the Customer 500 wishes to purchase multiple CCDLT's with the same Broken 502, they must still manually repeat the process for each digital currency that they wished to purchase making the process unnecessarily complex.

In contrast, the invention described herein allows the creation of a blockchain based indexed record consisting of unique customized grouping of various Cryptocurrencies or Digital Ledger Tokens (collectively abbreviated as CCDLTs) which significantly reduces both the complexity and time required to purchase multiple digital currencies. It also provides an effective method for a consumer to efficiently analyze multiple digital currencies by enabling the consumer to organize and group different digital currencies together. One embodiment describes a unique method that allows a consumer to create a Unique Cryptocurrency or Digital Ledger Index (UCCDLTI). As can be seen by anyone skilled in the art of technology and finance, the creation of a UCCDLTI can have applications in various fields including digital currency based gaming services and digital currency based brokerage services.

It can be seen that the creation of a blockchain based recorded UCCDLTI can have applications in electronic terminal based game playing, thus enabling the player to create competitive games utilizing different blockchain based recorded UCCDLTI's. As can be seen by anyone skilled in the art of digital gaming, a variety of competitive games can be created from the utilization of different blockchain based recorded UCCDLTI's, for example:
A single-player game wherein a gamer creates a UCCDLTI and tracks its performance relative to other UCCDLTI's over a specified period of time.
Single-player games wherein a gamer selects different UCCDLTI's with the intention of tracking the UCCDLTI's performance relative to stock market indices.
Multi-player games wherein the gamers compete with each other by selecting different UCCDLTI's and tracking the performance of their UCCDLTI selections relative to the other gamers selections.
Multi-player games wherein the gamers compete with each other by selecting different UCCDLTI's and tracking the performance of their UCCDLTI selections relative to public leaderboards (score boards) or public ranking mechanisms.

A further embodiment of this invention describes a method and apparatus for purchasing blockchain based recorded UCCDLTI's for example, it enables the consumer to purchase multiple cryptocurrencies or digital ledger tokens (CCDLT's) with a single order instead of manually placing multiple individual purchase orders. It can be appreciated by anyone skilled in the art of stock brokerage that the utilization of a UCCDLTI can simplify the stock or digital currency purchasing process for consumers. By virtue of this invention, a consumer is able to purchase “X” US Dollars of a blockchain based recorded UCCDLTI containing digital currencies “A-Z” using a single order, rather than placing multiple separate orders: an individual order for digital currency “A”, an individual order for digital currency “B”, and so on for each of the rest of the digital currencies. Currently if a consumer wishes to purchase individual CCDLT's one at a time, they have many options (REFERENCE 12) as there are many CCDLT brokers available for individual purchases. While these brokerage companies differentiate themselves from one another in various ways such as lower fees or better customer service, none of these brokers provide the customer with the ability to purchase multiple digital currencies simultaneously via utilization of a blockchain based recorded UCCDLTI. If a consumer wishes to purchase multiple digital currencies with a single order, he is not able to do so because no such service or method currently exists.

It can be appreciated that the method and apparatus for blockchain based recorded UCCDLTI creation and UCCDLTI purchasing as described in this patent application may have applications in other industries as well. As can be seen by anyone skilled in the art of technology and finance, including stock brokerage service, the blockchain based recorded UCCDLTI purchasing embodiment of this patent application may have applications in the fields of financial securities brokering, including, but not limited to: stocks, bonds, stock options, debt agreements, real estate/land, commodities, financial commodity instruments, tangible property, and, fiat-currencies (currency that a government has declared to be legal tender, but it is not backed by a physical commodity) (REFERENCE 13). It can be appreciated that the method and apparatus for blockchain based recorded UCCDLTI creation and UCCDLTI transactions described in this patent may be utilized by sources other than an individual person, such as, for example, a group of people, an institution/legal entity, a software program, or artificial intelligence. Furthermore it can be seen by anyone skilled in the art that an entity or software program dedicated to creating UCCDLTI's may be able to generate index combinations that would ordinarily be too complicated and complex for an individual user to create by themselves.

Furthermore the method and apparatus for blockchain based recorded UCCDLTI creation and UCCDLTI transactions described in this patent application may also have applications to any blockchain based systems that rely upon multiple computers or stock exchanges as required by a blockchain technology based product or service. These may include use of blockchain for simultaneous transactions or exchange of any group of physical items, contracts or assets, in which each item or element may be identified as either an individual block, or as a group within a blockchain transaction. For example, this method and apparatus may be used for any security offering which needs to manipulate multiple assets identified as either individual blocks or as a group in a block such as an inventory of physical items, geographic areas, or property ownership.

### REFERENCES

1. https://www.investopedia.com/terms/c/cryptocurrency.asp
2. https://masterthecrypto.com/differences-between-cryoticurrency-coins-and-tokens.
3. https://www.investopedia.com/terms/b/blockchain.asp
4. https://www.technologyreview.com/s/607947/the-cryptocurrency-market-is-growing-exponentially/18)
5. https://www.cryptocoinsnews.com/lat-research-exponential-growth-crypto-markets-5-trillion/19)
6. https://www.technologyreview.com/s/513661/bitcoin-isnt-the-only-cryptocurrency-in-town/20)
7. http://www.investopedia.com/term/s/soft-fork.asp
8. https://www.investopedia.com/terms/h/hard-fork.asp
9. https://medium.com/@lightcoin/the-differences-between-a-hard-fork-a-soft-fork-and-a-chain-split-and-what-they-mean-for-the-769273f358c9
10. https://www.investitin.com/crypto-fund-list/24)
11. https://www.coindesk.com/bitcoin-brokers-trade-millions-without-exchange
12. https://blockgeeks.com/guides/best-cryptocurrency-exchanges/26)
13. https://www.investopedia.com/terms/f/fiatmoney.asp#ixzz5KcKm7Hef

### BRIEF DESCRIPTION OF THE DRAWINGS

One embodiment of this invention and its advantages may be described with reference to the associated figures:

FIG. 1 illustrates an example showing how a blockchain protocol records an individual Cryptocurrency or Digital Ledger Token (CCDLT) transaction.

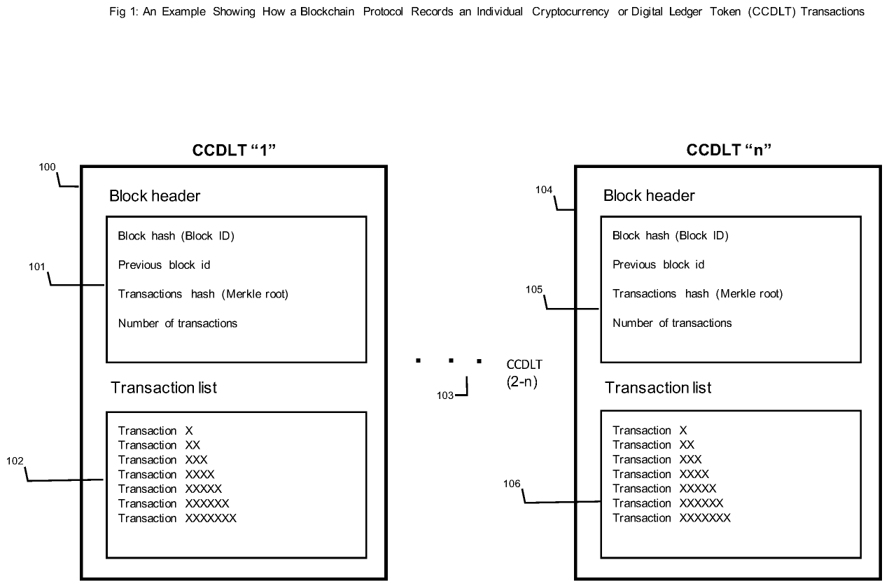

FIG. 2 is PRIOR ART. It is the methodology employed by a different U.S. patent that illustrates an example of scraping data for the purposes of creating an index.

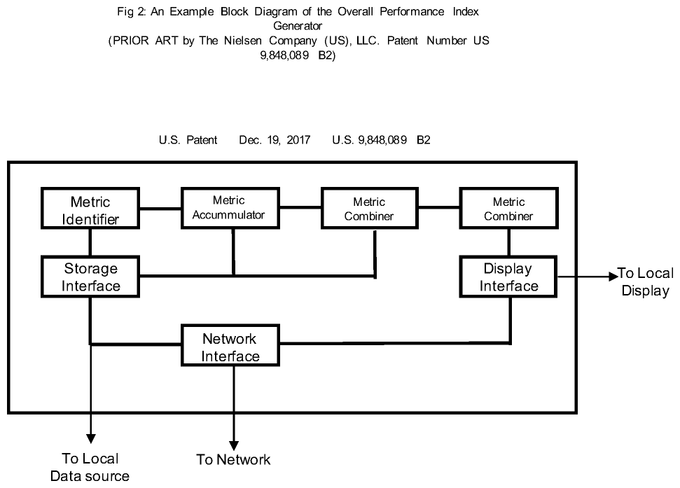

FIG. 3 is PRIOR ART. It is the methodology employed by a different U.S. patent that illustrates an example of index creation.

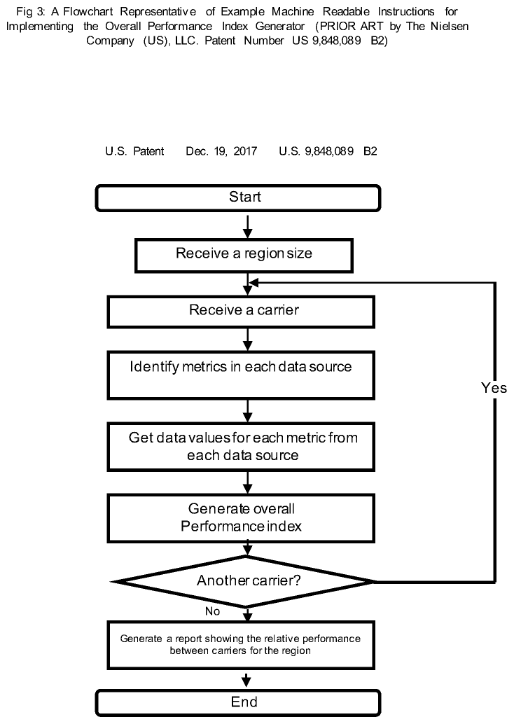

FIG. 4 illustrates the typical process by which a Customer 400 purchases a single CCDLT present-day.

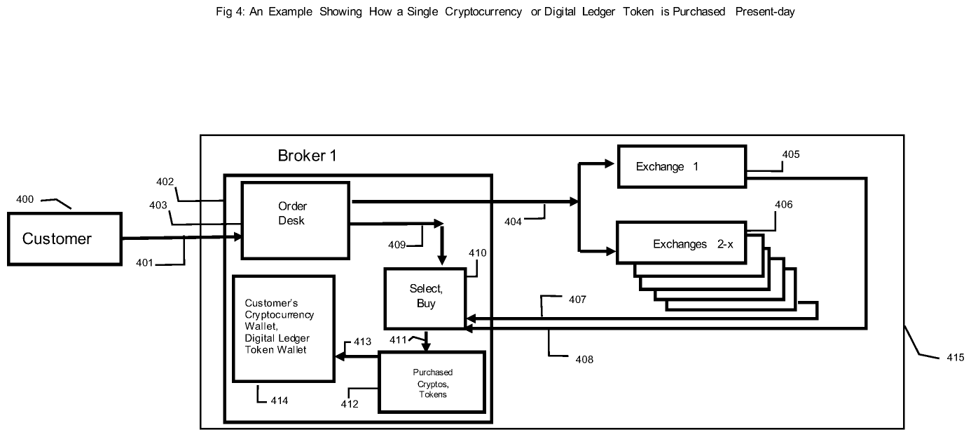

FIG. 5 illustrates the typical process by which a Customer 500 purchases multiple CCDLTs present-day.

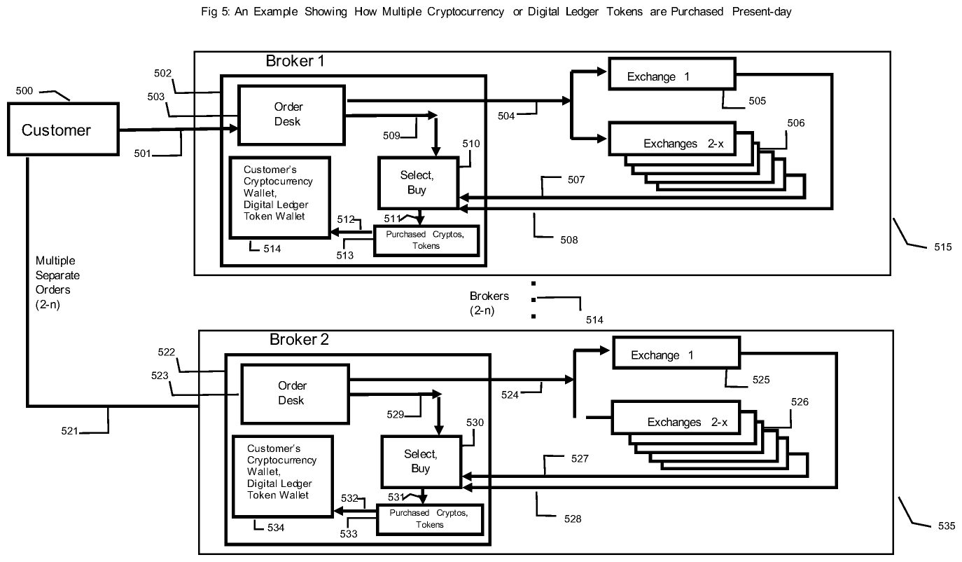

FIG. 6 Illustrates the process by which a User is able to construct and create a blockchain recorded Unique Cryptocurrency or Digital Ledger Token Index (UCCDLTI) via a UCCDLTI Creation Entity, as well as the process by which a User is able to access blockchain recorded UCCDLTIs created by a UCCDLTI creation entity.

FIG. 7A Illustrates the three different processes by which a list of Cryptocurrency's or Digital Ledger Tokens (CCDLT's) may be weighted before they are recorded in a blockchain protocol.

FIG. 7B Illustrates the process by which a list of Cryptocurrency's or Digital Ledger Tokens (CCDLT's) may be weighted via Fiat Currency before it's recorded as a Unique Cryptocurrency or Digital Ledger Token Index (UCCDLTI) in a blockchain protocol.

FIG. 7C Illustrates the process by which a list of Cryptocurrency's or Digital Ledger Tokens (CCDLT's) may be weighted via Number of Tokens before it's recorded as a Unique Cryptocurrency or Digital Ledger Token Index (UCCDLTI) in a blockchain protocol.

FIG. 7D Illustrates the process by which a list of Cryptocurrency's or Digital Ledger Tokens (CCDLT's) may be weighted via Percentage before it's recorded as a Unique Cryptocurrency or Digital Ledger Token Index (UCCDLTI) in a blockchain protocol.

FIG. 8 Illustrates an example of a UCCDLTI recorded in a Blockchain Protocol.

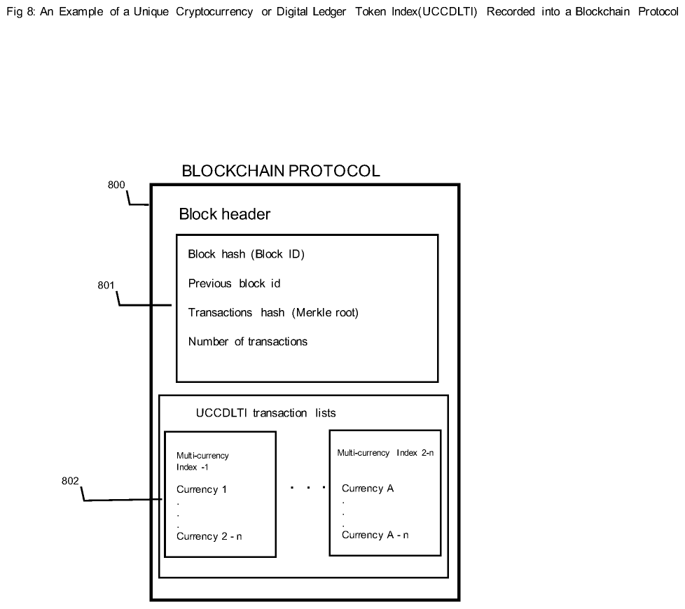

FIG. 9 Illustrates examples of applications for a blockchain recorded UCCDLTI.

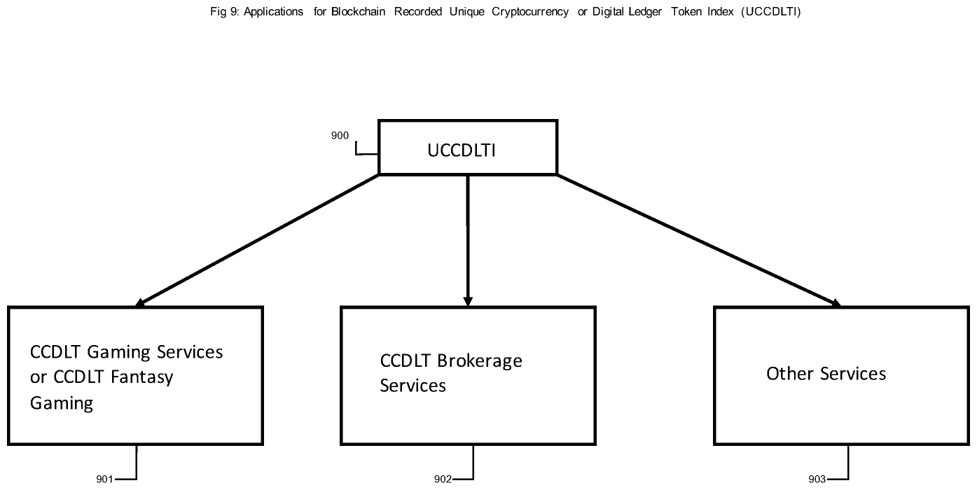

FIG. 10 Illustrates the process by which a Customer can buy multiple CCDLT's with a single order via utilization of a blockchain recorded UCCDLTI.

FIG. 11 Illustrates the process by which a Customer can sell multiple CCDLT's with a single order via utilization of a blockchain recorded UCCDLTI.

### DETAILED DESCRIPTION OF EMBODIMENTS

One embodiment of this invention describes a method and apparatus that facilitates the construction and creation of a blockchain based recorded Unique Cryptocurrency or Digital Ledger Token Index (UCCDLTI). This facilitation of UCCDLTI creation allows a consumer to create various combinations of different CCDLT's. In addition, the UCCDLTI is immutable because it is recorded into a proprietary blockchain protocol when created ensuring that its' unique composition cannot be altered or tampered with. In addition, this facilitation provides a safe method for consumers to experiment with various CCDLT combinations because it does not require the transfer or transacting of real fiat-currency. It can be appreciated that this embodiment has applications in various areas including CCDLT Gaming Services, CCDLT Educational Services, & CCDLT Analytics/Data services. However, the applicability of the blockchain based recorded UCCDLTI should not be restricted to imputable transactions only. The blockchain based recorded UCCDLTI has many applications within the CCDLT brokerage industry, wherein real fiat-currency or real CCDLT's are transacted.

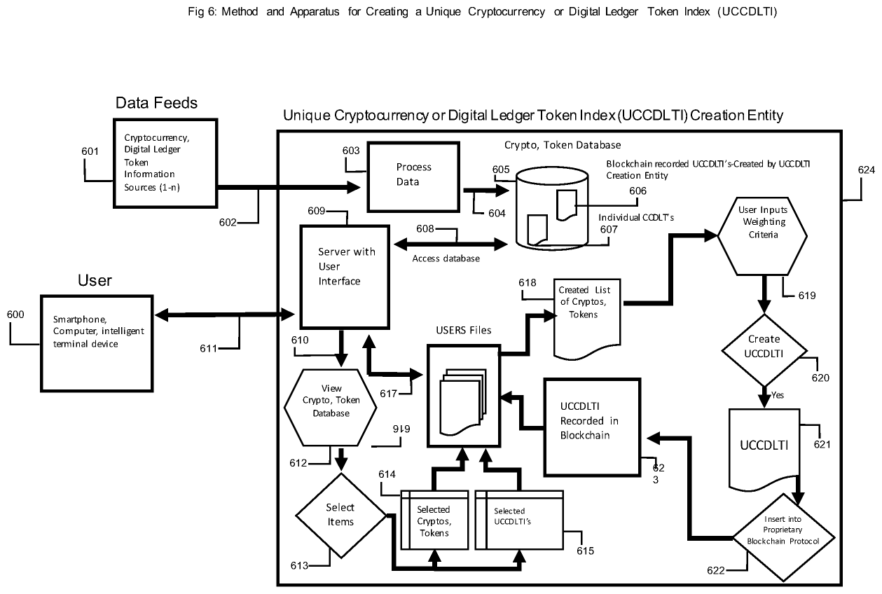

One embodiment of this invention describes a Method and Apparatus for creating a Unique Cryptocurrency or Digital Ledger Token Index (UCCDLTI) that is recorded in a proprietary blockchain protocol (FIG. 6). To create a blockchain recorded UCCDLTI 623, a User 600 of a smartphone, computer or intelligent terminal device establishes a Data Connection 611 to a Server with User Interface 609 belonging to a UCCDLTI Creation Entity 624. When the User 600 connects to the Server with User Interface 609, he is presented with a curated list of CCDLT's 607. The curated list of individual CCDLT's 607 include various pieces of information for each individual CCDLT, including: current price, price history, market capitalization information, news and descriptions.

The curated list of individual CCDLT's 607 is derived from Data Feeds 601. Data Feeds 601 are a series of CCDLT Information Sources 1-n that are derived from the world wide web in this exemplary embodiment. The Information Sources 1-n could also be derived from various sources, including publicly accessibly websites and data providing vendors. In addition, these CCDLT Information Sources 1-n contain various pieces of information for each individual CCDLT, including: current price, price history, market capitalization information, news and descriptions. The Data Feeds 601 are sent to the UCCDLTI Creation Entity's 624 Process Data 603 mechanism. The Process Data 603 mechanism is programmed to identify and retain specific pieces of information. The pieces of information that are kept are then sent to the CCDLT Database 605 and saved as a curated list of individual CCDLT's 607. The Server with User Interface 609 can then access the CCDLT Database 605, thus allowing the User 600 to gain access to the curated list of individual CCDLT's 607. This process is automated and could use Machine Learning techniques to select the pieces of information in other embodiments. It can be appreciated that if the User 600 does not wish to create their own blockchain based recorded UCCDLTI, they may have the option to access blockchain based recorded UCCDLTI's created by the UCCDLTI Creation Entity 606.

In one embodiment of this invention, the User 600 is able to view and browse the curated list of individual CCDLT's 607 via the View CCDLT Database 612 mechanism. As the User 600 browses through the various pieces of CCDLT information, they can select which CCDLT's to include in the blockchain based recorded UCCDLTI being built via the Select Items 613 mechanism. Once the User 600 has finished selecting CCDLT's 614 that are to be included in the blockchain based recorded UCCDLTI, the CCDLT's are saved to the USERS Files 616. Once the User 600 adds their Selected Cryptocurrencies or Digital Ledger Tokens (CCDLT's) 614 to the USERS Files 616, they can use these selected CCDLT's to compile a Created List of CCDLT's 618.

In one embodiment of this invention, the UCCDLTI Creation Entity 624 stores and maintains the User's 600 data via the USERS Files 616. It can be appreciated that the USERS Files 616 store information regarding the User's 600 activity within the UCCDLTI Creation Entity 624 that is necessary for the facilitation of creating a blockchain recorded UCCDLTI 623, including the Selected Cryptocurrencies or Digital Ledger Tokens (CCDLT's) 614, the Created List of CCDLT's 618, the Weighting Criteria 619, the List of Weighted Items 123, and blockchain recorded UCCDLTI's Created by the UCCDLTI Creation Entity 606. The User's 600 blockchain recorded UCCDLTI(s) 623 are also saved and stored to the USERS Files 616. In addition, in the event that the User 600 elects to create an account with the UCCDLTI Creation Entity 624, the information that they provide for account creation may also be stored in the USERS Files 616. The User 600 can access their unique USERS Files 616 via the Server with User Interface 609.

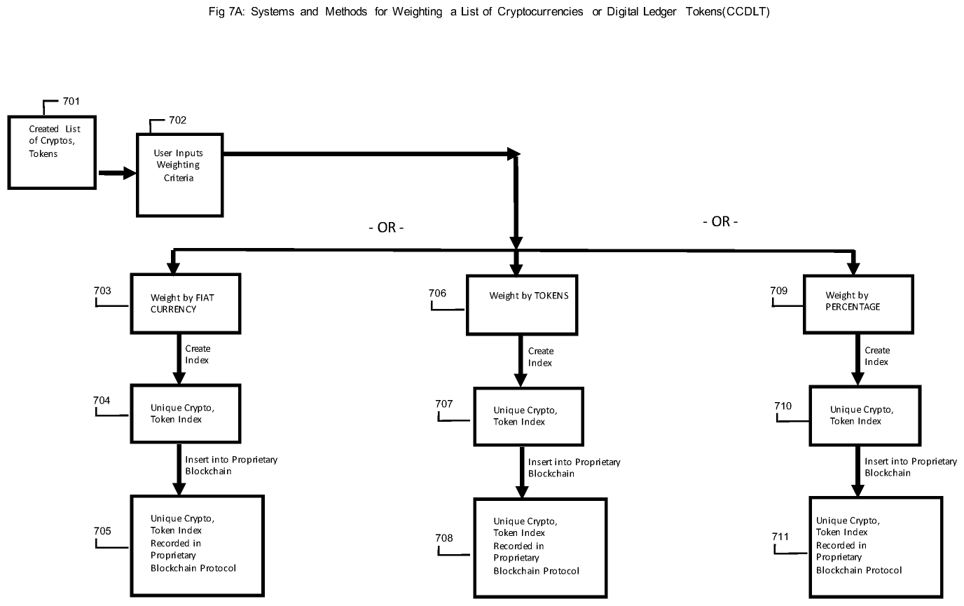

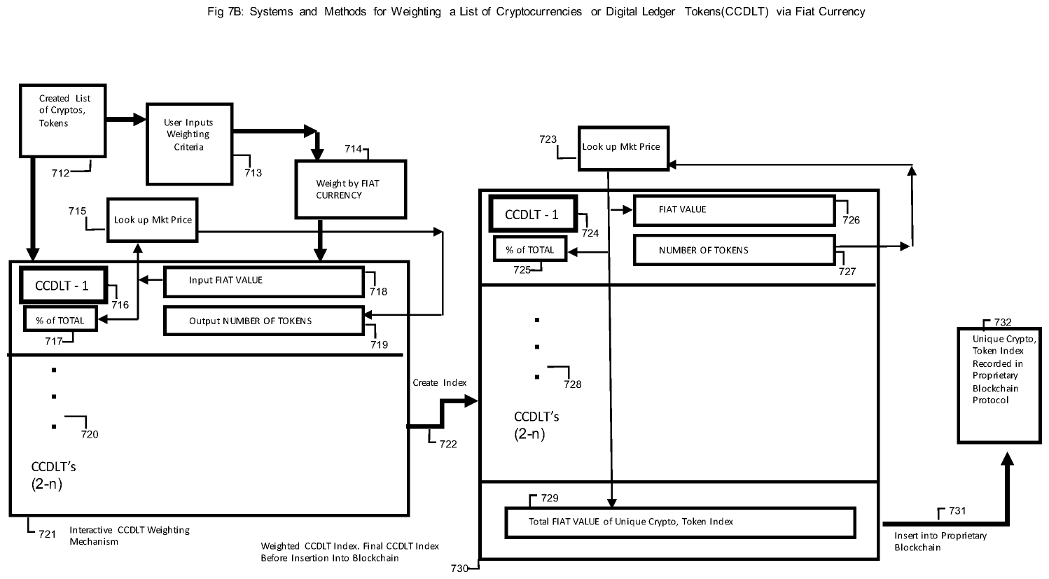

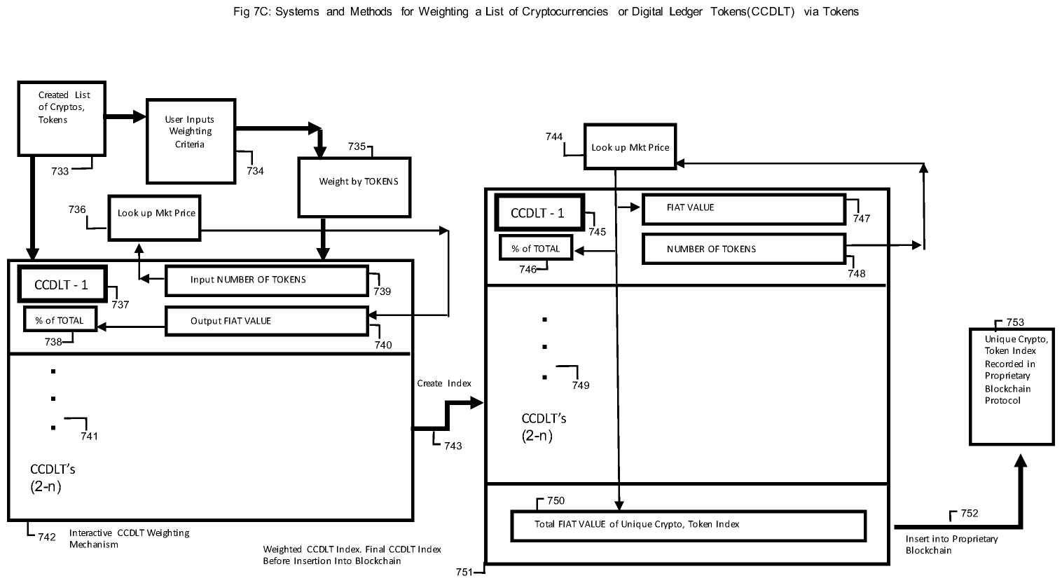

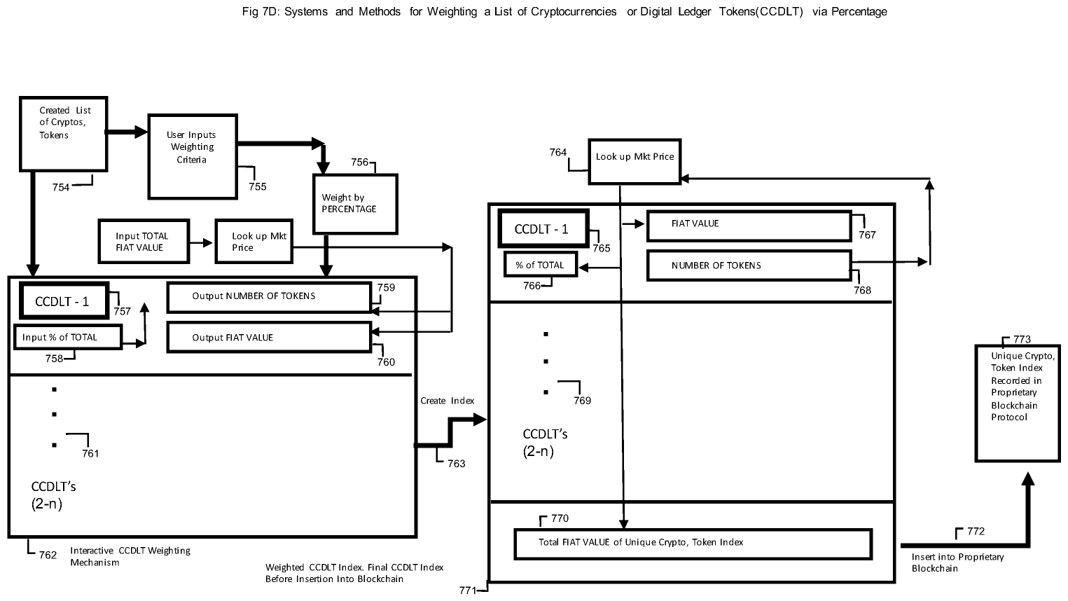

In one embodiment of this invention, the User 600 can access his Created List of CCDLT's 618 via the USERS Files 117 or via the Weighting Criteria 619 mechanism. The User 600 chooses how to weight his Created List of CCDLT's 618 by selecting from three different processes: Fiat Currency (FIG. 7B), Tokens (FIG. 7C), or Percentage (FIG. 7D).

Upon completion of the weighting via the Weighting Criteria 619 mechanism, the User 600 is presented with a Create UCCDLTI 620 mechanism. Once the User 600 creates a UCCDLTI 621 via the Create UCCDLTI 620 mechanism, their UCCDLTI 621 is recorded into a proprietary blockchain protocol via the Insert into Proprietary Blockchain Protocol 622 mechanism. Upon insertion into a proprietary blockchain protocol, the User's 600 UCCDLTI 621 is finalized as a Blockchain Recorded UCCDLTI 623 and saved to the USERS Files 616.

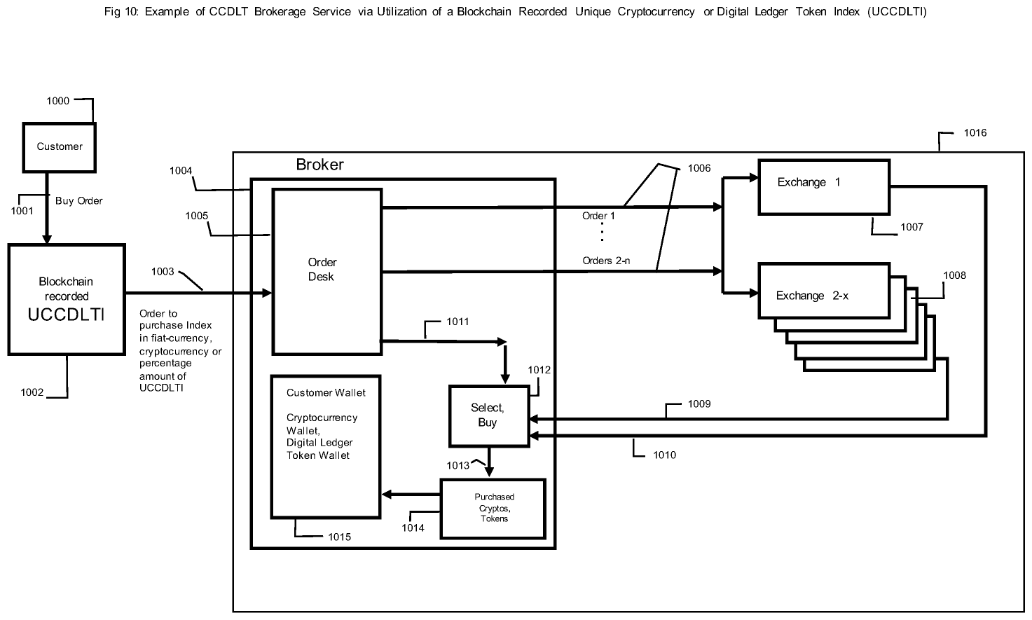

One embodiment of this invention includes CCDLT purchasing services via utilization of a UCCDLTI (FIG. 10). By utilizing a Blockchain Recorded UCCDLTI 1002 a Customer 1000 can purchase multiple CCDLT's simultaneously with a single order. When a Customer 1000 wishes to purchase multiple CCDLT's simultaneously with a single order, he submits a Buy Order 1001 to purchase X amount of a Blockchain Recorded UCCDLTI 1002, where X is equal to the number of fiat-currency units or cryptocurrency units that the Customer 1000 wishes to commit to the Buy Order. The Customer's 1000 Buy Order 1001 is routed to the CCDLT Broker's 1004 Order Desk 1005 where it is processed. Upon receiving the Customer's 1000 Buy Order 1003 to purchase X amount of Blockchain Recorded UCCDLTI 1002, the Order Desk 1005 performs the necessary calculations to initiate multiple Orders 1-n 1006 on the behalf of the Customer 1000. The number of different orders contained within the Order Desk's 1005 outgoing Orders 1-n 10006 will correspond to the number of CCDLT's contained within the Blockchain Recorded UCCDLTI 1002.

For every single CCDLT contained in the Blockchain Recorded UCCDLTI 1002, the Order Desk 1005 sends an individual order to multiple Exchanges: Exchange1 1007 including Exchanges2-x 1008. In the event that Exchange1 1007 has a contra-order(s) available to fill the Buy Order(s) 1006, Exchange1 1007 sends the Contra-Order(s) Notification 1010 to the Broker 1004. Similarly, in the event that any of the Exchanges2-x 1008 has a contra-order(s) available to fill the Buy Order(s) 1006, Exchanges2-x 1008 sends the Contra-Order(s) Notification 1009 to the Broker 1004. Once the Broker 1004 is notified about the Contra-Orders 1009/1010 that are available, the Order Desk 1005 Selects 1012 the orders to fill his own Customer's 1000 Buy Order 1003. The resulting Purchased CCDLT's 1014 are then transferred to the Customer's CCDLT Wallet(s) 1015 which are housed at the Broker 1004.

FIG. 10 demonstrates an instance in which a Customer 1000 wishes to purchase the CCDLT's that comprise Blockchain Recorded UCCDLTI 1002 which has been previously created as referenced in FIG. 7A in 705, 708, 711. The Customer 1000 may purchase the CCDLT(s) using any accepted “exchange unit” recognized by the exchange. For example, fiat-currency (e.g. USD, Yen, Euro, etc.), cryptocurrency (e.g. Bitcoin, Ethereum, etc.), or any other accepted method of exchange (e.g. notes, physical items, or contracts).

Since the Consumer 1000 wishes to purchase “X” Exchange Units worth of the Blockchain Recorded UCCDLTI 1002, the Order Desk 1005 will send out multiple separate Orders 1-n 1006 to Exchange1 1007 and Exchanges 2-x 1008. If Exchange1 1007 or Exchanges2-x 1008 have a contra-order(s) 1009/1010 available, the Order Desk 1005 Selects and Buys 1012 CCDLT(s) from these Contra-Orders 1009/1010 on behalf of Customer 1000. Upon completion of the multiple Purchase Orders 1006, the Broker 1004 deposits the Purchased CCDLT's 1014 into the Customer's CCDLT Wallet(s) 1015. The Customer's 1000 Buy Order 1001 is now complete with a single order, the customer has purchased multiple CCDLT's.

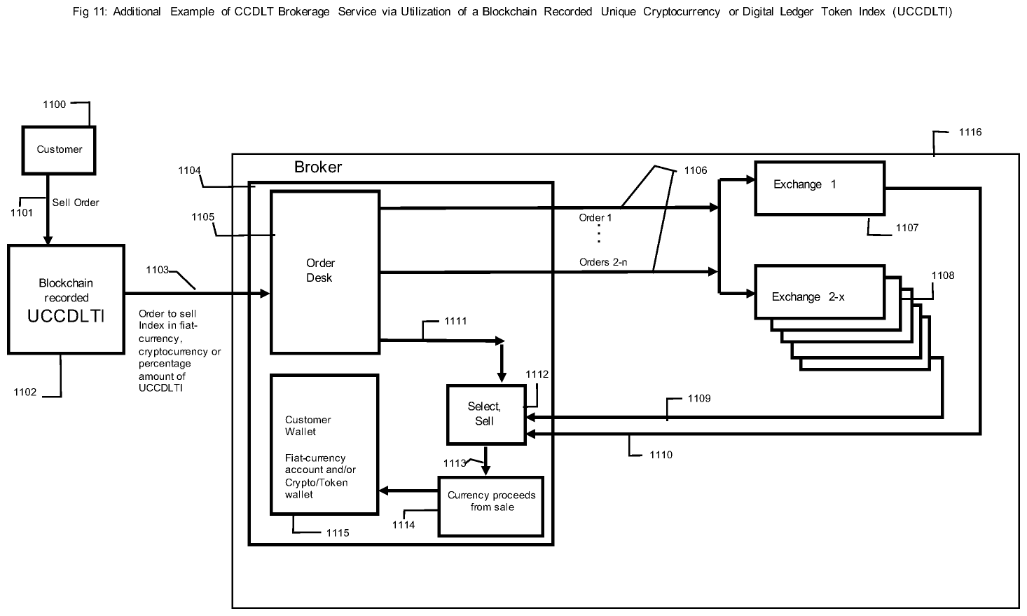

One embodiment of this invention includes CCDLT selling services via utilization of a UCCDLTI (FIG. 11). As seen in FIG. 10 and FIG. 11, selling multiple CCDLT's via utilization of a Blockchain based Recorded UCCDLTI works in the exact same manner as via utilization of a Blockchain based Recorded UCCDLTI. Utilizing the previous example involving FIG. 10, should the Customer 1100 wish to sell the individual CCDLT's held in their UCCDLTI with a single order, he simply sends a Sell Order 1101 to the Order Desk 1105 to sell X amount of the UCCDLTI they own, where X is equal to or less than the combined “Exchange Unit” value of the Blockchain Recorded UCCDLTI 1102. The Order Desk 1105 then sends the Sell Orders 1106 to the various CCDLT Exchanges 1107/1108, and upon completion of the transaction, the transaction net amount is deposited into the Customer's 1115 account housed with the Broker 1104.

We claim:

1. An apparatus comprising:
a. computer network system with at least one database;
b. at least one secure user terminal for accessing the computer network;
c. at least one computer node for storing transaction data;
d. at least one system interface that allows for the creation of a unique index recorded on a blockchain protocol;
e. a plurality of transactable asset.

2. The computer system in claim 1 wherein the computer network operates using a blockchain protocol.

3. The computer system in claim 1 wherein the transactable assets are digital currencies.

4. The computer system in claim 1 wherein the transactable assets are fiat currencies.

5. The computer system in claim 1 wherein the transactable assets are digital ledger tokens.

6. The computer system in claim 1 wherein the transactable assets are public stocks.

7. The computer system in claim 1 wherein the database maintains unique index records from the blockchain protocol.

8. The transactable assets of claim 1 are unique index records in the database.

9. The computer system in claim 1 wherein the transactable assets are bonds.

10. The computer system in claim 1 wherein the transactable assets are debt agreements.

11. The computer system in claim 1 wherein the transactable assets are commodities.

12. The computer system in claim 1 wherein the transactable assets are financial commodity instruments.

13. The computer system in claim 1 wherein the transactable assets are real estate/land.

14. The computer system in claim 1 wherein the transactable assets are tangible property.

15. The unique indexes recorded on a blockchain protocol of claim 8 are utilized for brokerage transactions.

16. The unique indexes recorded on a blockchain protocol of claim 8 are utilized for fantasy gaming transactions.

17. A method comprising:
a. At least one computer network system; and
b. A plurality of data feeds that contain information about transactable assets connected to a database or computer network system; and
c. At least one database connected to a processing mechanism wherein the transactable asset information is curated and compiled into a data set; and
d. At least one data set connected to an interface wherein transactable assets can be selected to create a unique index; and
e. At least one interface connected to a weighting mechanism wherein the unique index is weighted;

18. The method in claim 17 wherein the unique index is recorded in a blockchain protocol.

19. The method in claim 17 further comprising the ability of an individual person to create a unique index recorded in a blockchain.
